(19) United States
(12) Patent Application Publication
(10) Pub. No.: US 2018/0211773 A1
(43) Pub. Date: Jul. 26, 2018

(54) Induction Charging System Having a Housing Structure Having Carbon Fibers That Are Without Contact

(71) Applicant: Bayerische Motoren Werke Aktiengesellschaft, Muenchen (DE)

(72) Inventor: Josef KRAMMER, Holzkirchen (DE)

(21) Appl. No.: 15/890,451

(22) Filed: Feb. 7, 2018

Related U.S. Application Data
(63) Continuation of application No. PCT/EP2016/065896, filed on Jul. 6, 2016.

(30) Foreign Application Priority Data
Aug. 25, 2015 (DE) 10 2015 216 157.9

(51) Int. Cl. H01F 38/14; B60L 11/18; H01F 27/02; H01F 27/06; H01F 27/28

(52) U.S. Cl. CPC H01F 38/14; B60L 11/182; H01F 27/28; H01F 27/06; H01F 27/02

(57) ABSTRACT

An induction charging system for inductively charging a motor vehicle is provided. The induction charging system includes an induction coil and a housing structure for the induction coil. The housing structure has carrier elements including carbon fibers, which are embedded in a base material in such a way that substantially all of the individual carbon fibers of a carrier element are arranged without contact in the carrier element. Alternatively, the individual carbon fibers are combined in carbon fiber bundles of at most 0.1 mm diameter and substantially all of the carbon fibers bundles are arranged without contact in the carrier element. A motor vehicle having such an induction charging system is also provided.

### CROSS REFERENCE TO RELATED APPLICATIONS

This application is a continuation of PCT International Application No. PCT/EP2016/065896, filed Jul. 6, 2016, which claims priority under 35 U.S.C. § 119 from German Patent Application No. 10 2015 216 157.9, filed Aug. 25, 2015, the entire disclosures of which are herein expressly incorporated by reference.

### BACKGROUND AND SUMMARY OF THE INVENTION

The invention relates to an induction charging system for inductively charging a motor vehicle, including an induction coil and a housing structure for the induction coil.

A coil unit is known from DE 10 2010 050 935 A1, in which the coil windings and a ferrite core are potted in a casting compound.

Induction charging systems of this type are used for contactlessly charging an electrical energy storage device of a motor vehicle, such as a rechargeable lithium-ion battery for example. For charging, the motor vehicle, in which a secondary coil is arranged, is to be placed above a primary coil as charging device over a relatively long time period, which primary coil emits a changing magnetic field.

By way of example, FIG. 1 shows a primary coil unit 1 arranged on or in the floor (e.g., carriageway, parking lot, garage), and a secondary coil unit 3 arranged on the underbody of a vehicle 2. An air gap is present between the primary coil unit 1 and the secondary coil unit 3. The air gap should, on the one hand, be as small as possible, in order to achieve a high efficiency of the induction charging system, and on the other hand, should be large, in order not to constitute an obstacle for the vehicle 2 or so as not to be damaged when driven over by the vehicle 2.

FIG. 2 shows the induction charging system from FIG. 1 in a somewhat more detailed manner. In the primary coil unit 1 and the secondary coil unit 3, a primary coil 4 and a secondary coil 5 are provided accordingly, which are in each case wound around a vertical axis and constructed to be as flat as possible in the vertical direction, so that the coil windings extend in the horizontal. The primary coil 4 is essentially structured identically to the secondary coil 5, but mirrored vertically, wherein the primary coil 4 is typically larger than the secondary coil 5. Ferrite cores 6 are provided for guiding the magnetic field lines. To protect the primary and secondary coils 4, 5, the coils are in each case embedded in a casting compound 7 made from magnetically neutral material. Thus, the secondary coil 5 must be protected from stone chipping and bottoming of the vehicle 2 (e.g., on curbs). The upper side of the primary coil 4 must offer protection against damage when being driven over (e.g., passenger cars, trucks) or against the indentation of stones.

FIG. 3 shows a sectional plan view of an induction coil, such as for example the primary coil 4 or the secondary coil 5. For example, the coil can be wound in an essentially square or round manner.

FIG. 4 shows the course of field lines during operation of the induction charging system. The primary coil 4 creates a magnetic field, the magnetic field lines of which are shown in FIG. 4. Some of the field lines run through both the primary and the secondary coil 4, 5, whereas other field lines only run through the primary coil 4. The portion of the field lines only running through the primary coil 4 is to be kept as small as possible for good efficiency. This is achieved for example by configuring the ferrite cores 6 guiding the field lines. On the other hand, it is to be taken into account that enclosure of the induction coils, which, as mentioned already, is required for protecting the induction coils, does not negatively affect the efficiency of the induction charging system.

An object of the invention is to create an induction charging system for inductive energy transmission, which offers good protection against mechanical damage and in the process negatively influences the efficiency as little as possible. This and other objects are achieved with an induction charging system in accordance with embodiments of the invention.

According to an exemplary embodiment of the invention, an induction charging system for inductively charging a motor vehicle is provided. The induction charging system includes an induction coil and a housing structure for the induction coil. The housing structure includes support elements having carbon fibers, which are embedded into a base material in such a manner that essentially all of the individual carbon fibers of a support element are arranged in the support element contactlessly. Alternatively, the individual carbon fibers are combined in carbon fiber bundles of maximum diameter 0.1 mm and essentially all of the carbon fiber bundles are arranged in the support element contactlessly. The term “essentially all” should clarify that support elements, in which, owing to tolerances or manufacturing defects, a very low number of carbon fibers or bundles do indeed touch, are also to be understood as falling within the protective scope of the invention. Preferably, “essentially all” means more than 90% of the carbon fibers or carbon fiber bundles within a support element. More preferably, “essentially all” means more than 95% of the carbon fibers or carbon fiber bundles within a support element. Because the carbon fibers do not touch, magnetic eddy currents cannot be formed. By way of this arrangement, it is possible to use the previously unsuitable carbon fibers as material for encapsulating an induction coil. The advantages of the carbon fibers lie in the stability thereof and the low weight.

According to a further exemplary embodiment of the invention, the base material is an electrically non-conductive material.

According to a further exemplary embodiment of the invention, the base material is resin, paint or plastic.

According to a further exemplary embodiment of the invention, the housing structure includes a floor element, on which the induction coil is arranged, wherein the floor element includes a support element in the form of a plate or a plurality of support elements in the form of struts.

According to a further exemplary embodiment of the invention, the housing structure includes a spacing structure, which fastens the floor element on a vehicle underbody, wherein the spacing structure includes a support element in the form of a plate or a plurality of support elements in the form of struts.

According to a further exemplary embodiment of the invention, the housing structure further includes an intermediate floor, wherein the induction coil is arranged between the floor element and the intermediate floor. The intermediate floor includes a support element in the form of a plate or a plurality of support elements in the form of struts.

According to a further exemplary embodiment of the invention, the carbon fibers of a support element are essentially all aligned unidirectionally.

According to a further exemplary embodiment of the invention, the carbon fibers of a support element are arranged in layers, wherein the carbon fibers inside a layer are essentially all aligned unidirectionally.

According to a further exemplary embodiment of the invention, the carbon fibers of two adjacent layers are aligned such that they are rotated by 90°.

According to a further exemplary embodiment of the invention, the individual carbon fibers or carbon fiber bundles are wrapped with an electrically non-conductive thread for maintaining distance. For example, the thread can be arranged in addition to the base material.

Furthermore, the invention provides a vehicle having such an induction charging system.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a view of an induction charging system from the prior art;

FIG. 2 is a detailed view of the induction charging system from FIG. 1;

FIG. 3 is a sectional plan view of an induction coil of the induction charging system from FIG. 1;

FIG. 4 illustrates the course of field lines during operation of the induction charging system from FIG. 1;

FIG. 5 is a view of a vehicle with an induction charging system according to an exemplary embodiment of the present invention;

FIG. 6 is a detailed view of a secondary coil unit of the induction charging system from FIG. 5;

FIG. 7a is a view of support elements in the form of struts;

FIG. 7b is a view of a support element in the form of a plate;

FIG. 8 is a view of a design of a support element;

FIG. 9 is a view of a wound carbon fiber;

FIG. 10 is a view of a different design of a support element; and

FIG. 11 is a view of a secondary coil unit of the induction charging system according to a further exemplary embodiment.

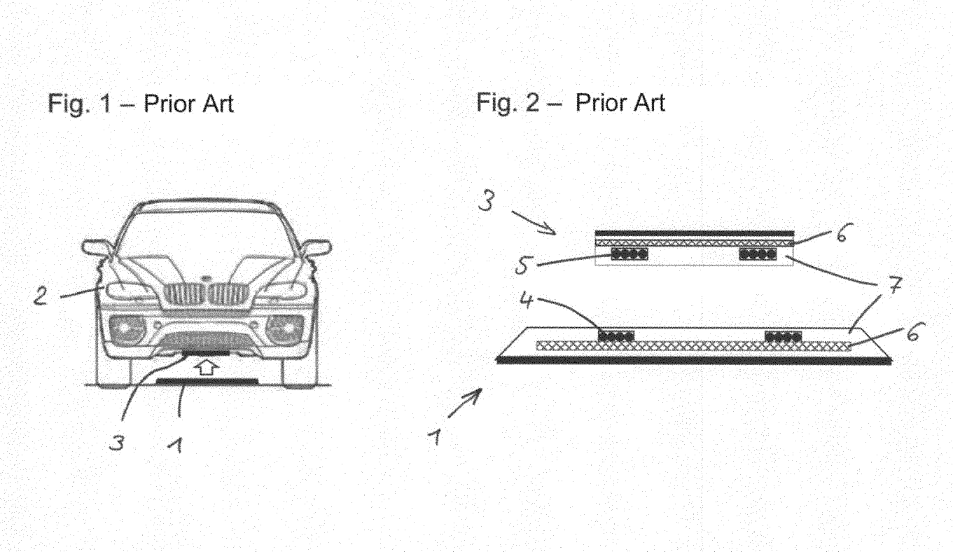

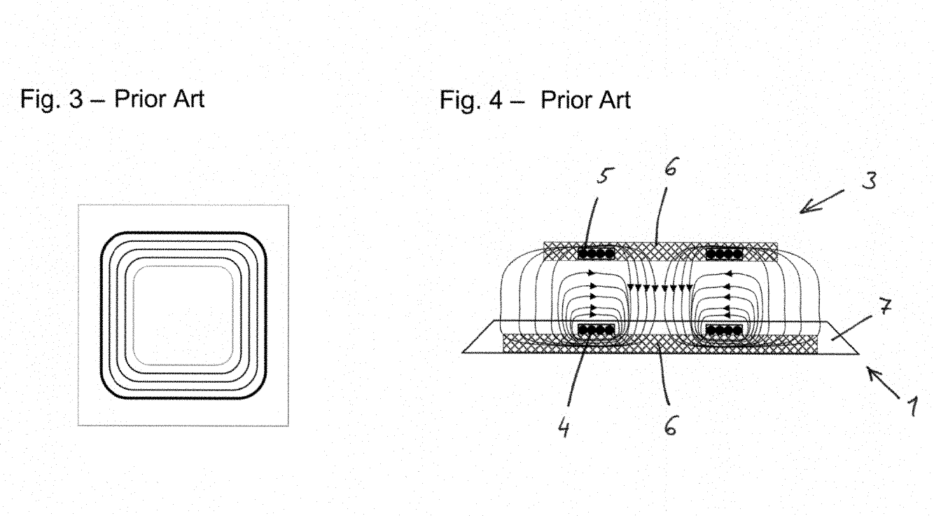

### DETAILED DESCRIPTION OF THE DRAWINGS

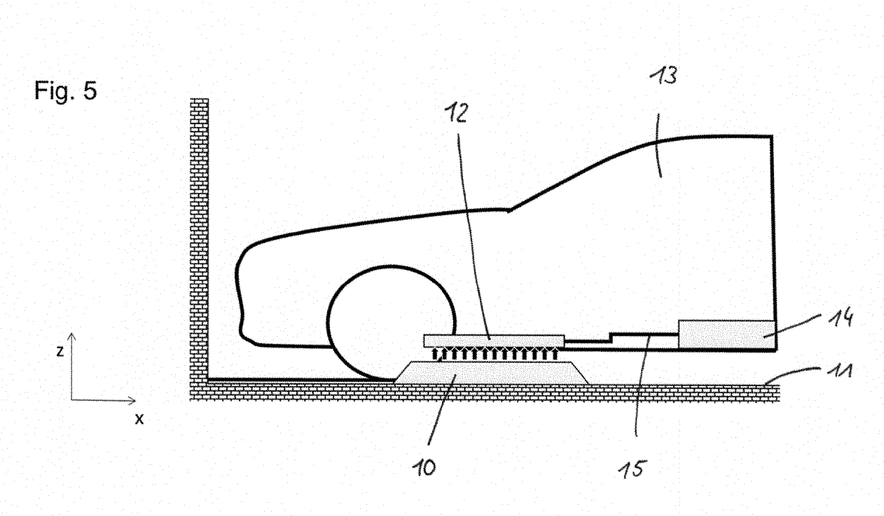

FIG. 5 schematically shows an induction charging system according to an exemplary embodiment of the present invention. The induction charging system includes a primary coil unit 10, which is mounted in or on a floor 11, for example a carriageway, a parking lot, a parking area or, as indicated in FIG. 5, a garage. The primary coil unit 10 interacts with a secondary coil unit 12, which is provided on or in a motor vehicle 13. The secondary coil unit 12 is preferably mounted on an underbody of the motor vehicle 13. The motor vehicle 13 has an electrical energy storage device 14, preferably a high-voltage rechargeable battery, such as for example a rechargeable lithium-ion battery, which is electrically connected via an electrical line 15 to the secondary coil unit 12 and can be charged inductively by way of the same. An air gap remains between the primary coil unit 10 and the secondary coil unit 12. The primary coil unit 10 emits a changing magnetic field for charging the energy storage device 14. The charging current required for charging the energy storage device 14 is created by induction as a result in the secondary coil unit 12.

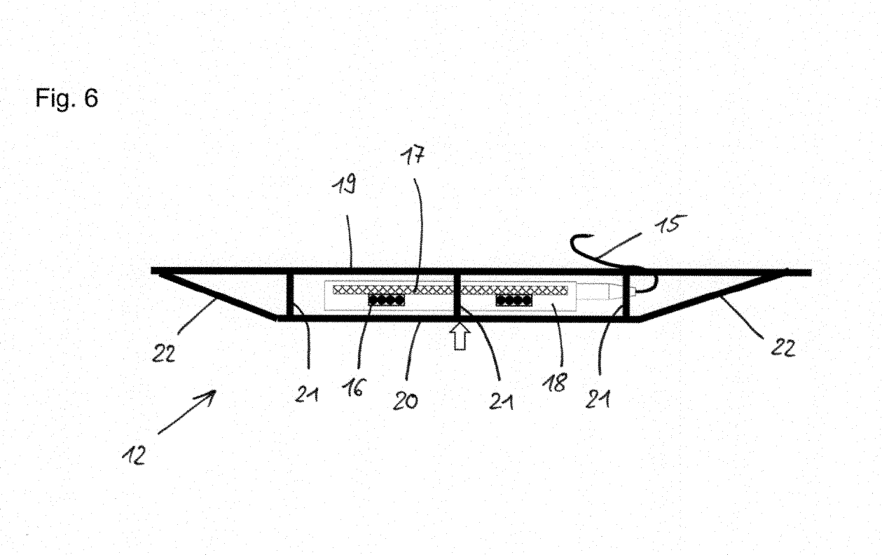

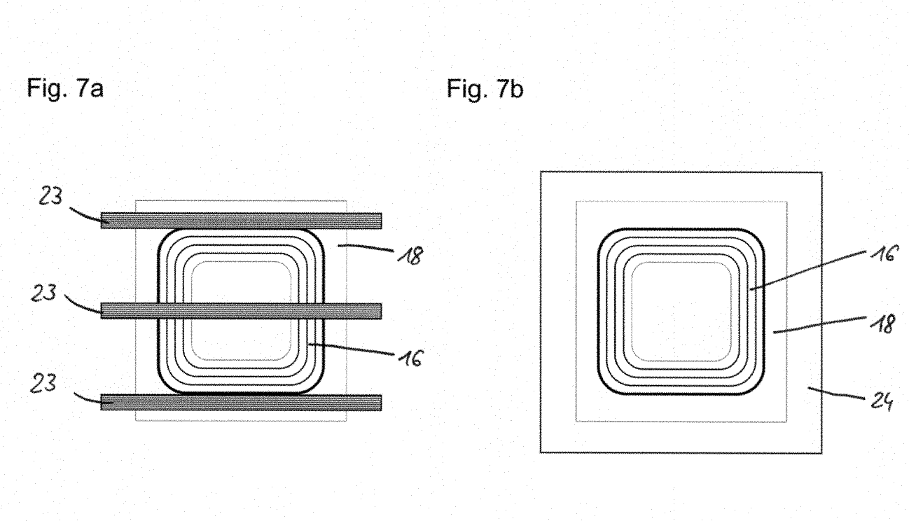

FIG. 6 shows the secondary coil unit 12 in a more detailed manner. The secondary coil unit 12 includes a secondary coil 16, the windings of which are wound around a vertical axis as center. The windings in this case essentially describe a square (cf. FIG. 7a, 7b) or round shape in a plan view, the center of which is clear. A ferrite core 17 is arranged on the side of the secondary coil 16 facing away from the primary coil. This is embedded together with the secondary coil 16 in a casting compound 18. The secondary coil 16 is connected to the electrical energy storage device 14 by way of the electrical line 15. According to the invention, the secondary coil unit 12 includes a housing structure, which supports and surrounds the secondary coil 16, and protects the latter from mechanical damage. The housing structure includes a fastening element 19, which is preferably fastened on a vehicle underbody, a floor element 20, a spacing structure 21 and side elements 22. The secondary coil 16 is arranged between the fastening element 19 and the floor element 20. The fastening element 19 is made from a material of high strength, for example aluminum. The floor element 20, the spacing structure 21 and the side elements 22 in each case include support elements or consist of support elements, which are explained more precisely in the following, and which are constructed in the form of plates or struts (for example with rectangular or round cross section) (see FIGS. 7a, 7b). The material of the support elements differs from the material of the fastening element 19 and has a stiffer modulus of elasticity and neutrality with respect to an alternating magnetic field, i.e., this is not a ferromagnetic material or a material which permits eddy currents. The support elements of the spacing structure 21 are essentially perpendicular to the fastening element 19 and to the floor element 20 and the floor element 20 is therefore spaced from the fastening element 19. As a result, the forces, which act on the housing structure, are distributed to two elements with spacing, which has the effect of a framework arrangement and leads to high strength and a reduction in the torsional forces. The support elements of the spacing structure can in this case be guided through openings in the composite made up of the secondary coil 16, ferrite core 17 and casting compound 18. The ends of the floor element 20 are connected to side elements 22 running obliquely to the fastening element 19.

FIG. 7a shows a design by way of example, in which the support elements of the floor element 20 are constructed in the form of struts 23. This saves weight compared to a flat design, but forces are essentially only absorbed well in one direction.

FIG. 7b shows a design by way of example, in which the support elements of the floor element 20 are constructed in the form of a plate 24. This design has a higher weight than struts, but forces are absorbed in two dimensions.

In the following, various designs of the support elements are described by way of example.

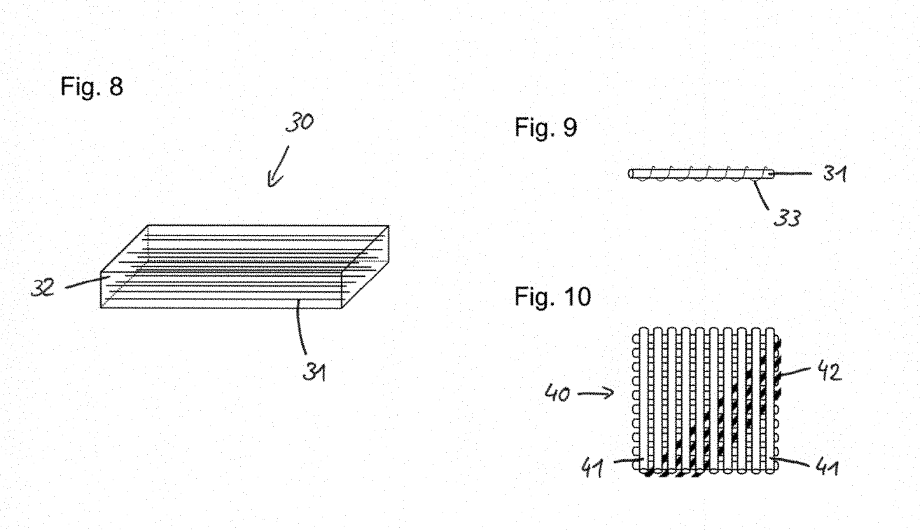

FIG. 8 shows a support element 30, which has a multiplicity of carbon fibers 31, wherein all of the carbon fibers 31 are arranged contactlessly with respect to one another inside a support element 30. For the sake of clarity, only one of the multiplicity of carbon fibers 31 is provided with a reference numeral 31 in FIG. 8. Alternatively, instead of individual contactless carbon fibers, these are contactless bundles of carbon fibers, wherein the bundles are not thicker than 0.1 mm in diameter. The inventors of this invention have found out that in the case of bundles of up to this diameter or individual carbon fibers, which do not touch one another, no magnetic eddy currents can be formed, because no current loops can be formed in the case of the conductive carbon fibers. Thus, a housing structure can be created which is neutral with respect to an alternating magnetic field.

Furthermore, all of the individual carbon fibers or bundles within the same support element 30 are aligned unidirectionally, i.e., the longitudinal directions essentially run in the same direction.

The spaced carbon fibers 31 or bundles can be embedded into a base material 32 in the spaced manner thereof. The base material 32 is an electrically non-conductive material, for example paint, plastic or resin, particularly epoxy resin. The spacing of the carbon fibers 31 or bundles can be achieved during embedding into the base material 32, for example by pre-stressing the carbon fibers 31 or bundles when being surrounded with the base material 32. In addition, it is possible to wrap the individual carbon fibers 31 or bundles with electrically non-conductive threads 33, e.g., aramid, as is illustrated in FIG. 9. Alternatively, the carbon fibers 31 or bundles are laid or weaved into a textile fabric, e.g., aramid. Furthermore, it is possible to space the individual carbon fibers 31 or bundles by way of painting of the individual carbon fibers 31 or bundles with an electrically non-conductive paint.

The spacing of the carbon fibers 31 or bundles can take place in addition to embedding into the base material 32.

FIG. 10 shows a different support element 40, which has a multiplicity of carbon fibers 41. In order to avoid repetitions, only the differences between the support element 30 and the support element 40 are described in the following. In the support element 40, the individual carbon fibers 41 or bundles are not all aligned unidirectionally, but rather are arranged in the form of layers, wherein all carbon fibers 41 or bundles are aligned unidirectionally inside a layer. The carbon fibers 41 or bundles of two adjacent layers are aligned differently, preferably they are rotated by 90°. In addition, a layer 42 made from electrically non-conductive fibers or textile can be arranged between two adjacent layers of carbon fibers 41 or bundles in each case.

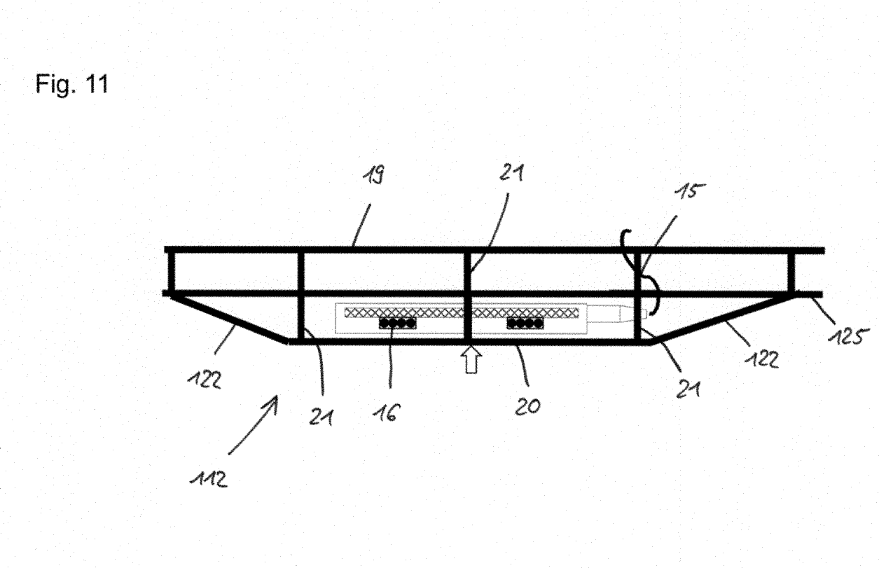

FIG. 11 shows a further exemplary embodiment of a secondary coil unit 112. In order to avoid repetitions, only the differences between the secondary coil unit 12 and the secondary coil unit 112 are described in the following. The secondary coil unit 112 additionally has an intermediate floor 125, which runs between the fastening element 19 and the floor element 20, preferably parallel to them. The secondary coil 16 is arranged between the intermediate floor 125 and the floor element 20. The intermediate floor 125 includes or consists of support elements 30, 40, as described previously. In contrast to the side elements 22, the side elements 122 do not connect the floor element 20 to the fastening element 19, but rather connect the floor element 20 to the intermediate floor 125.

Whilst the invention has been illustrated and described in detail in the drawings and the preceding description, this illustration and description is to be understood as illustrative or exemplary and not as limiting and it is not intended to limit the invention to the disclosed exemplary embodiments. The mere fact that certain features are mentioned in different dependent claims should not be construed as indicating that a combination of these features could not also be used advantageously. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMBERS

1 Primary coil unit
2 Vehicle
3 Secondary coil unit
4 Primary coil
5 Secondary coil
6 Ferrite cores
7 Casting compound
10 Primary coil unit
11 Floor
12 Secondary coil unit
13 Motor vehicle
14 Electrical energy storage device
15 Electrical line
16 Secondary coil
17 Ferrite core
18 Casting compound
19 Fastening element
20 Floor element
21 Spacing structure
22 Side elements
23 Struts
24 Plate
30 Support element
31 Carbon fiber
32 Base material
40 Support element
41 Carbon fibers
42 Layer made from non-conductive material
112 Secondary coil unit
122 Side elements
125 Intermediate floor

What is claimed is:

1. An induction charging system for inductively charging a motor vehicle, comprising:
an induction coil; and
a housing structure for the induction coil, wherein
the housing structure comprises support elements including carbon fibers, which are embedded into a base material in such a manner that essentially all of the individual carbon fibers of a respective support element are arranged in the support element contactlessly, or that the individual carbon fibers are combined in carbon fiber bundles of maximum diameter 0.1 mm and essentially all of the carbon fiber bundles are arranged in the support element contactlessly.

2. The induction charging system according to claim 1, wherein the base material is an electrically non-conductive material.

3. The induction charging system according to claim 2, wherein the base material is resin, paint or plastic.

4. The induction charging system according to claim 1, wherein
the housing structure comprises a floor element, on which the induction coil is arranged, and
the floor element comprises a support element in the form of a plate or a plurality of support elements in the form of struts.

5. The induction charging system according to claim 4, wherein
the housing structure comprises a spacing structure, which fastens the floor element on a vehicle underbody, and
the spacing structure comprises a support element in the form of a plate or a plurality of support elements in the form of struts.

6. The induction charging system according to claim 4, wherein
the housing structure further comprises an intermediate floor,
the induction coil is arranged between the floor element and the intermediate floor, and
the intermediate floor comprises a support element in the form of a plate or a plurality of support elements in the form of struts.

7. The induction charging system according to claim 5, wherein
the housing structure further comprises an intermediate floor,
the induction coil is arranged between the floor element and the intermediate floor, and
the intermediate floor comprises a support element in the form of a plate or a plurality of support elements in the form of struts.

8. The induction charging system according to claim 1, wherein the carbon fibers of the support element are essentially all aligned unidirectionally.

9. The induction charging system according to claim 1, wherein
the carbon fibers of the support element are arranged in layers, and
the carbon fibers inside a layer are essentially all aligned unidirectionally.

10. The induction charging system according to claim 9, wherein the carbon fibers of two adjacent layers are aligned such that they are rotated by 90°.

11. The induction charging system according to claim 1, wherein the individual carbon fibers or carbon fiber bundles are wrapped with an electrically non-conductive thread for maintaining distance.

12. A vehicle, comprising:
an induction charging system according to claim 1.
